(19) United States
(12) Patent Application Publication
(10) Pub. No.: US 2011/0189642 A1
(43) Pub. Date: Aug. 4, 2011

(54) Musical System for Waking Young Children

(75) Inventor: Claudia Kespy-Yahi, Montmorency (FR)

(73) Assignee: CAP ENFANTS

(21) Appl. No.: 13/056,209

(22) PCT Filed: Aug. 5, 2009
(86) PCT No.: PCT/FR09/00982

§ 371 Date: Apr. 15, 2011

(30) Foreign Application Priority Data
Aug. 8, 2008 (FR) 08/04534

(51) Int. Cl. G09B 5/04

(52) U.S. Cl. 434/319

(57) ABSTRACT

A musical early-learning system in particular for young children, the system comprising a shelter or wall (10) having acoustic properties and that defines a space that is accessible to children, being fitted with loudspeakers (16) and control switches (18) connected to a computer system (20) so that the children actuating the control switches (18) cause predetermined sequences of sounds to be reproduced inside the shelter (10).

The invention relates to a musical early-learning system for young children, the system being of the type for installing in a creche, in a hospital building, in a school, or in any location that is open to the public.

Children aged less than 18 months perceive sounds better than images and their inner ears are forming during that period. It is therefore particularly advantageous to make children of that age hear a variety of noises and sounds in order to accustom them to a range of sounds that is as broad as possible in frequency and in tone so as to train their ears, so as to have favorable consequences on their intellectual development and in particular on their capacities for learning languages and music.

To this end, the invention provides a musical early-learning system for young children, the system being characterized in that it comprises:
a shelter or wall having acoustic properties and defining a space that is accessible to children, said space being fitted with sound playback means such as loudspeakers, for example, and control means for controlling the playback means, the control means being actuatable by children; and
a computer system connected to the sound playback means and to their control means in order to reproduce in said space sounds that have been selected by the control means actuated by the children.

In the space defined by the acoustic shelter or wall, forming a “musical bubble”, children are isolated and protected from outside sound disturbances and they become particularly attentive to the sounds that are generated inside said space when they actuate the control means made available to them. The sounds played back comprise sounds of a variety of natures and origins, such as for example: speech, songs, background sounds, musical sounds, pieces of music played on different instruments, etc.

The control means for controlling the sound playback means fitted in said space comprise sensors of the touch or touch-sensitive type.

It is also possible to equip the space with a detector for detecting the presence or the entry of a child, said detector serving for example to activate the above-mentioned control means.

It is also possible to install a microphone in said space, the microphone being connected to the computer system and serving to pick up a sound emitted by a child or a noise made by the child in order to reproduce it in the space or to add it to, or to combine it with, the sounds reproduced by the sound playback means.

In practice, the sounds reproduced in said space may be recorded in memories of the computer system, e.g. on CD type media or via a data transmission network such as the Internet.

It is thus possible to install one or more sound banks in the computer system, each bank comprising a series of sequences of different sounds (speech, songs, music, etc.) that are representative of a region, a country, a culture, a period, a musical style, a background (townscape noises, seaside noises, country noises, farmyard noises, etc.).

In a preferred embodiment of the invention, the shelter or wall that defines the above-mentioned space is hemi-spherical or hemi-ovoid in shape and includes openings through which children can pass, together with a carpet and means for fastening it or holding it to the ground.

In a variant, the shelter may be spherical, cylindrical, or semi-cylindrical in shape.

In a variant embodiment, the musical early-learning system of the invention is movable, for example comprising an inflatable shelter fitted with the above-mentioned means so as to constitute a “traveling musical bubble”.

The invention also relates to derived products, such as for example an educational package fitted with sound reproduction means of the same type as those described above, making it possible in any room to listen to the recordings of the sound banks of the system of the invention.

The invention can be better understood and other characteristics, details, and advantages thereof appear more clearly on reading the following description made by way of example with reference to the accompanying drawings, in which:

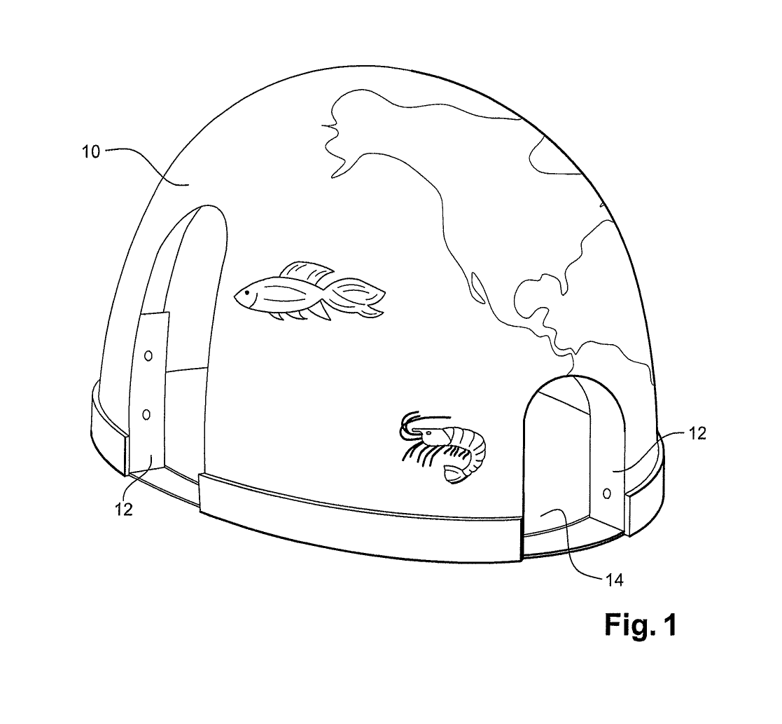

FIG. 1 is a diagrammatic perspective view of the system of the invention; and

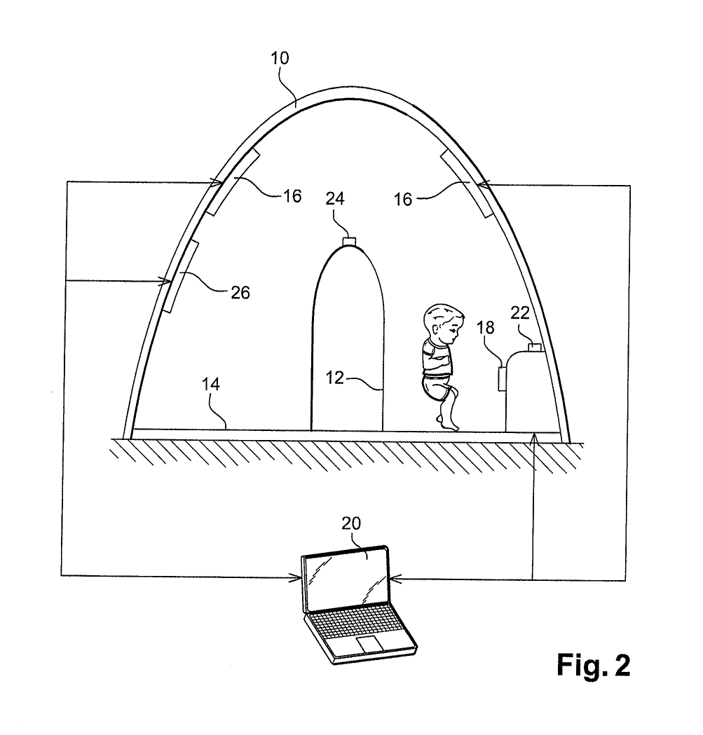

FIG. 2 is a diagrammatic section view of the system, showing its main pieces of equipment.

The musical early-learning system for young children, shown diagrammatically in FIGS. 1 and 2, essentially comprises a shelter or wall 10 of hemi-spherical or hemi-ovoid shape for installing in a room in a building such as a creche, a hospital, a school, etc., and including openings 12 of different heights through which children can pass. The shelter 10 is made of two thicknesses of fabric mounted on a lightweight frame and defining between them a gap of several centimeters that is filled with a material having acoustic properties.

The fabrics of the shelter may receive a variety of decoration, such as for example a globe and images of animals or fishes, as shown diagrammatically in FIG. 1.

In a variant, the shelter may be made by being molded out of plastics material.

A carpet 14 is installed inside the shelter 10, the carpet being made of a suitable material, such as a foam, for example, in order to cushion falls, and to give children an agreeable sensation of comfort, enabling them to undertake psychomotor activity (somersaults, etc., . . . ).

The inside of the shelter 10 is fitted firstly with sound playback means such as loudspeakers 16 and secondly with control means 18, such as switches or pushbuttons of the touch or touch-sensitive type that are connected together with the loudspeakers 16 to inputs of a computer system 20, e.g. of the microcomputer type, comprising at least one microprocessor, and working memories and memories for recording signals corresponding to sounds that are to be reproduced by the loudspeakers 16. The computer system 20 is programmed to cause the loudspeakers 16 to reproduce predetermined sequences of sound when a child actuates a control 18.

The number of controls 18 inside the shelter 10 generally lies in the range one to ten, with each control being for causing different sounds to be reproduced.

It is also possible to install at least one microphone 22 inside the shelter 10, the microphone serving to pick up the sounds or noises produced by a child inside the shelter 10 in order to transmit them to the computer system 20 and to reproduce them, to add them to, or to combine them appropriately with the sounds reproduced by the loudspeakers 16.

It is also possible to fit the system with one or more presence detectors 24 or detectors for detecting entry of a child into the inside of the shelter 10, said detector(s) 24 serving, for example, to activate the system if it has gone to sleep automatically after a predetermined period of non-use.

It is also possible to provide means 26 inside the shelter 10 for displaying images, e.g. such as a video screen, serving to display animated scenes under the control of the computer system 20 and/or on actuation of the controls 18 by a child.

Variable lighting means may also be installed in the shelter, these means being controlled by the computer system 20 and/or by the switches 18.

Furthermore, audible, tactile, and visual games may be installed in the shelter, together with various means for diffusing odors.

The above-described “musical bubble” may be used in a very large number of different ways:

For example, it is possible to reproduce therein sounds and music that are representative of a given region or culture for a certain length of time in order to accustom the ears of children to those sounds, and then change region or culture, and so on, in order to accustom children to varieties of sounds that are as varied as possible, in particular voice and musical sounds.

Children inside the shelter 10 can be left free to act as they see fit, or they may be accompanied by adults overseeing their activities.

The musical bubble may also be used for putting on entertainments for a small group of children.

It may also be fitted with games enabling sounds to be produced, e.g. comprising sound pipes for blowing into or for tapping in order to create a rhythm, water games that generate noises, etc.

It is possible to make a “traveling” version of the system of the invention, e.g. comprising an inflatable shelter fitted with the same sound reproduction means as those described above or with means that are similar.

It is also possible to provide an educational package containing sound reproduction or playback means making it possible to listen to the sounds that are to be reproduced in the system of the invention.

1. A musical early-learning system for young children, the system comprising:
a shelter or wall having acoustic properties and defining a space that is accessible to children, said space being fitted with sound playback means such as loudspeakers and control means for controlling the playback means, the control means being actuatable by children; and
a computer system connected to the sound playback means and to their control means in order to reproduce in said space sounds that have been selected by the control means actuated by the children.

2. A system according to claim 1, wherein the sounds played back comprise sounds of a variety of natures and origins, these sounds comprising speech, songs, background sounds, musical sounds, pieces of music played on different instruments.

3. A system according to claim 1, further including at least one microphone installed in said space connected to the computer system in such a manner that the sounds picked up by the microphone, and including a noise or a sound generated by a child, can be reproduced in the space or added to or combined with a sound reproduced in the space.

4. A system according to claim 1, wherein the control means of the sound playback means comprise switches or pushbuttons of the touch type.

5. A system according to claim 1, further including at least one detector for detecting the presence or the entry of a child into said space.

6. A system according to claim 1, wherein the sounds reproduced in said space are recorded in memories of the computer system or via a data transmission network.

7. A system according to claim 1, wherein said space is fitted with at least one screen for displaying images and variable lighting means under the control of the computer system andof the control means that are actuatable by children.

8. A system according to claim 1, wherein the shelter or wall is of hemi-spherical or hemi-ovoid shape and includes openings through which children can pass, together with a carpet and means for fastening it or holding it to the ground.

9. A system according to claim 1, and being for installing in a creche, in a hospital building, in a school, or in any other location that is open to the public.

10. A system according to claim 1, wherein the shelter is of the inflatable type.

11. A system according to claim 1, further including an educational package fitted with means for reproducing or playing back the sounds that are to be reproduced in the above-mentioned system.
